(19) United States
(12) Patent Application Publication
(10) Pub. No.: US 2005/0222696 A1
(43) Pub. Date: Oct. 6, 2005

(54) Controller system and controller for mechatronics device

(75) Inventors: Fumio Ozaki, Kanagawa-ken (JP); Hideaki Hashimoto, Kanagawa-ken (JP); Hirokazu Sato, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/086,414

(22) Filed: Mar. 23, 2005

(30) Foreign Application Priority Data
Mar. 25, 2004 (JP) 2004-089919

(51) Int. Cl. G05B 19/42; G06F 19/00

(52) U.S. Cl. 700/87; 700/245

(57) ABSTRACT

A controller system comprises a mechatronics device comprising a first connector inputting or outputting signals, and a memory which stores characteristic information showing characteristics of the signals input and output through the first connector; and a controller, which controls the mechatronics device, comprising a second connector which is electrically connected to the first connector, a reconfigurable circuit which outputs control signals controlling the mechatronics device, the reconfigurable circuit being changed to a suitable circuit structure for the mechatronics device, and a processor outputting an instruction to the reconfigurable circuit to change the circuit structure according to the characteristic information.

### CROSS-REFERENCE TO RELATED APPLICATION

This application is based upon and claims the benefit of priority from the prior Japanese Patent Applications No. 2004-89919, filed on Mar. 25, 2004, the entire contents of which are incorporated herein by reference.

### BACKGROUND OF THE INVENTION

1. Field of the Invention

The present invention relates to a controller system and a controller for a mechatronics device.

2. Background Art

As a mechatronics device like a robot has various kinds of configurations, an input-output signal (hereafter, called I/O) is greatly dependent on the mechatronics device. Accordingly, it has been difficult to control a variety of mechatronics devices with a single general-purpose controller (refer to Japanese Patent Application Laid-open No. 2003-178044 (JP-A)).

A technique by which a computing system is dynamically reconfigured has been discloses in JP-A 2003-178044. According to this technique, the computer system is reconfigured by a configuration in which a signal path is dynamically changed. When a display, and the like are controlled, it is enough to change a signal path as described above, that is, to change a connection method.

However, only the change in the signal path has not been enough because the I/Os of the mechatronics device simultaneously includes digital I/Os, and analog ones.

The object of the present invention is to provide a control system which can control a variety of mechatronics devices.

### SUMMARY OF THE INVENTION

An aspect of the present invention is to provide a control system which can control a variety of mechatronics devices. A controller system according to an embodiment of the present invention comprises
a mechatronics device comprising a first connector inputting or outputting signals, and a memory which stores characteristic information showing characteristics of the signals input and output through the first connector, and
a controller, which controls the mechatronics device, comprising a second connector which is electrically connected to the first connector; a reconfigurable circuit which outputs control signals controlling the mechatronics device; the reconfigurable circuit being changed to a suitable circuit structure for the mechatronics device; and a processor outputting an instruction to the reconfigurable circuit to change the circuit structure according to the characteristic information.

A controller system according to another embodiment of the present invention comprises a mechatronics device comprising a first connector inputting or outputting signals; and a first memory which stores identification information by which the mechatronics device is specified, and
a controller, which controls the mechatronics device, comprising a second connector which is electrically connected to the first connector, a second memory which stores characteristic information of signals input and output through the second connector; the second memory storing characteristic information corresponding to the identification information; a reconfigurable circuit which outputs a control signal controlling the mechatronics device, the reconfigurable circuit being changed to a suitable circuit structure for the mechatronics device; and a processor selecting the characteristic information from the second memory on the basis of the identification information received from the mechatronics device, and outputting an instruction to the reconfigurable circuit to change the circuit structure according to the characteristic information.

A controller according to another embodiment of the present invention, which controls a mechatronics device, comprises a connector which is electrically connected to the mechatronics device; a reconfigurable circuit which outputs control signals controlling the mechatronics device, the reconfigurable circuit being changed to a suitable circuit structure for the mechatronics device; and a processor outputting an instruction to the reconfigurable circuit to change the circuit structure according to a characteristic information of the mechatronics device, the characteristic information being sent from the mechatronics device connected to the connector.

A controller according to another embodiment of the present invention, which controls a mechatronics device, comprises a connector which is electrically connected to the mechatronics device; a memory which stores identification information by which the mechatronics device is specified, the memory storing characteristic information corresponding to the identification information; a reconfigurable circuit which outputs control signals controlling the mechatronics device, the reconfigurable circuit being changed to a suitable circuit structure for the mechatronics device; and a processor selecting the characteristic information from the memory on the basis of the identification information received from the mechatronics device, and outputting an instruction to the reconfigurable circuit to change the circuit structure according to the characteristic information.

### BRIEF DESCRIPTION OF THE DRAWINGS

FIG. 1 is a block diagram of a controller system 100 according to a first embodiment of the present invention;

FIG. 2 is a schematic diagram showing characteristic information in storage units 151 and 152;

FIG. 3 is a flow chart showing an operation flow of the controller system 100;

FIG. 4 shows a specific example of XML data stored in the storage unit 151 or 152;

FIG. 5 is a flow chart showing an operation flow of the controller system according to the second embodiment;

FIG. 6 is a block diagram of a DC motor 301 and a controller 300 according to the third embodiment of the present invention;

FIG. 7 is a drawing showing a configuration in which a DC motor 302 provided with a potentiometer 312, in stead of the DC motor 301, is connected to a controller 300;

FIG. 8 is a flow chart showing an operation flow according to the third embodiment;

FIG. 9 is a flow chart showing the sequence of steps for the position control;

FIG. 10 is a block diagram of a controller system 400 according to a fourth embodiment of the present invention;

FIG. 11 is a block diagram of a controller system 500 according to the fifth embodiment of the present invention; and

FIG. 12 is a flow chart showing an operation flow of the controller system 500.

### DETAILED DESCRIPTION OF THE INVENTION

Hereinafter, embodiments according to the present invention will be explained, referring to drawings. These embodiments do not limit the present invention.

### First Embodiment

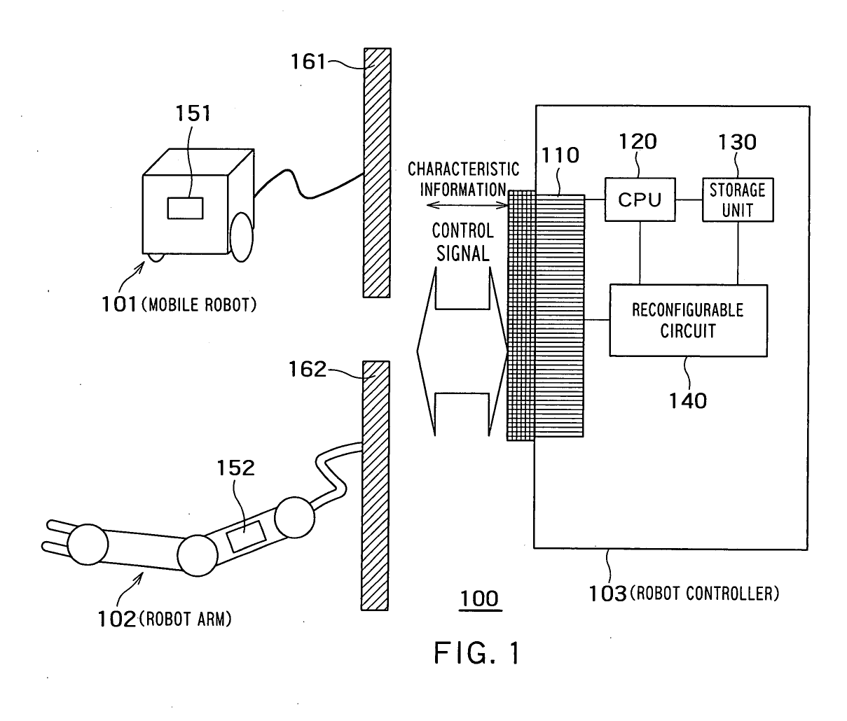

FIG. 1 is a block diagram of a controller system 100 according to a first embodiment of the present invention. The controller system 100 comprises: a robot controller 103; a mobile robot 101; and, a robot arm 102. The robot controller 103 comprises: a connector 110; a CPU 120; a storage unit 130 and a reconfigurable circuit 140. The mobile robot 101 comprises a storage unit 151 and a connector 161, and the robot arm 102 includes a storage unit 152 and a connector 162. Here, though the connectors 110, 161, and 162 are exaggerated for illustration in the drawing, the connector 110 is installed as a component element in the controller 103, the connector 161 is installed as a component element in the mobile robot 101, and the connector 162 is installed as a component element in the robot arm 102.

The connectors 110, 161, and 162 are a male or female (plug or jack) connector. And the connectors 110 and 161 can be electrically connected with each other, and the connectors 110 and 162 can be connected in the same manner. Accordingly, either of the connector 110 or the connector 161 has a configuration in which a plurality of connecting pins (not shown) are arranged, and the other has a receiving unit corresponding to the connecting pins in such a way that electrical connection is realized by engagement with the above connecting pins. The connectors 110, and 162 functions just as is the case with the connectors 110 and 161.

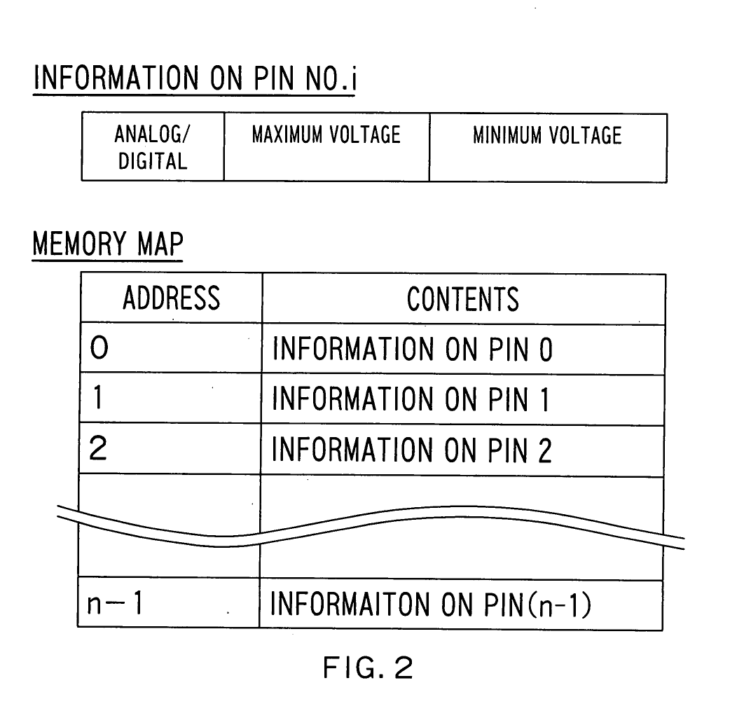

The storage unit 151 stores characteristic information on a control signal exchanged for communication between the mobile robot 101 (hereinafter, also called the robot 101) and the controller 103 for communication in order to control the robot 101, and the storage unit 152 stores characteristic information on a control signal exchanged between the robot arm 102 (hereinafter, also called the robot 102) and the controller 103 for communication in order to control the robot 102. The above characteristic information is information, which represents the characteristic of a signal which passes through a connecting pin for input and output, for each connecting pin. For example, as shown in FIG. 2, the characteristic information is information on the maximum voltage and the minimum voltage for signals passing through each connecting pin in the connector 161 or 162 for input and output, and the kind by which it is determined whether the signal is an analog or digital signal. Moreover, the characteristic-information may include information on the frequency and the like of the control signal, other than the above information on the voltages and the kind. And, the storage units 151 and 152 store information on each connecting pin for each address as shown in a memory map of FIG. 2. The storage units 151 and 152 may be a read-only memory (ROM), or a rewritable ROM.

When the connector 110 is connected to the connector 161, the CPU 120 reads the characteristic information from the storage unit 151, and outputs an instruction, by which the circuit structure of a reconfigurable circuit 140 is changed, to the circuit 140. Similarly, when the connector 110 is connected to the connector 162, the CPU 120 reads the characteristic information from the storage unit 152, and outputs the above instruction. Therewith, the CPU 120 instructs the storage unit 130 to transmit a program for reconfiguration. The storage unit 130 stores a program for reconfiguration for the reconfigurable circuit 140, and transmits the above program to the circuit 140 according to the instruction from the CPU 120. The storage unit 130 may be, for example, a ROM.

The circuit structure of the reconfigurable circuit 140 is changed to a suitable one for a robot connected to the connector 110, and the circuit 140 outputs a control signal suitable for the robot. Though the reconfigurable circuit 140 may be a static reconfigurable circuit, the circuit 140 may preferably be a dynamic reconfigurable circuit. Thereby, the circuit structure of the reconfigurable circuit 140 can be changed every one clock of a signal. Moreover, though the reconfigurable circuit 140 has been used as a circuit which can be reconfigured in the present embodiment, a field programmable gate array (FPGA), in stead of the reconfigurable circuit, may be adopted as a reconfigurable circuit. Here, when the static reconfigurable circuit and the FPGA are used as a reconfigurable circuit 140, a configuration for the inside of the controller 103 can be changed only once when the robot controller 103 is connected to a robot for the first time.

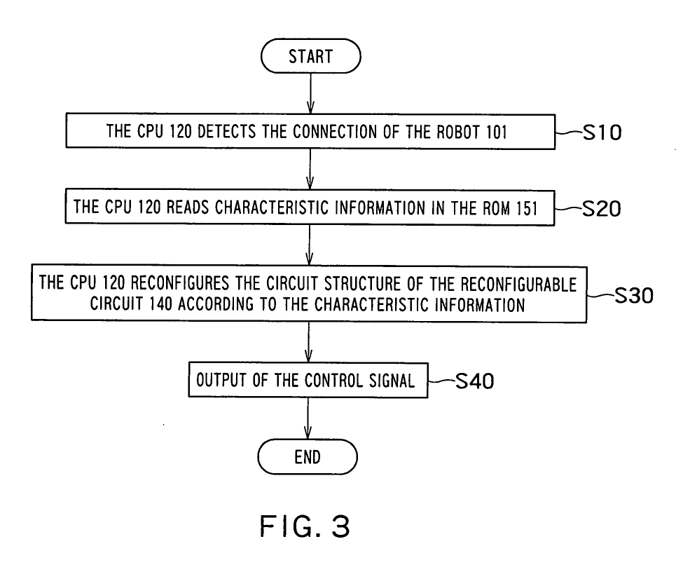

FIG. 3 is a flow chart showing an operation flow of the controller system 100. It is assumed that the robot 101 is connected to the controller system 100. In the first place, when the robot 101 is connected to the controller system 100, the CPU 120 in the controller system 100 detects the connection between the system and the robot 101 (S10). For example, when the CPU 120 regularly monitors an electric characteristic (a resistance, a voltage, and a current) of a certain connecting pin or a certain receiving unit, and the electric characteristic of the above connecting pin or the receiving unit is remarkably changed, the CPU recognizes that the robot is connected to the system.

Then, the CPU 120 reads characteristic information in the ROM 151 (S20). More specifically, the CPU 120 reads the characteristic information from the storage unit 151 through a part of a connection portion between the connectors 110 and 161. For example, the CPU 120 reads the characteristic information from the storage unit 151 through a part of the connecting pins in the connector 161 and a receiving unit in the connector 110 corresponding to the above connecting pin. Here, the part of the connecting pins in the connector 161, and, the receiving unit in the connector 110 corresponding to the part of the connecting pins are set beforehand to be prepared for communication of the characteristic information. At this step, the CPU 120 reads pieces of data at addresses of 0 through N−1 in the storage unit 151 shown in FIG. 2 one by one.

Subsequently, the CPU 120 reconfigures the circuit structure of the reconfigurable circuit 140 according to the characteristic information (S30). More specifically, the reconfigurable circuit 140 is reconfigured in such a way that the circuit 140 complies with voltage information for a control signal as shown in FIG. 2, and kind information by which it is determined whether a signal is an analog or digital signal.

Then, the reconfigurable circuit 140 outputs the control signal to be output through the remaining connecting pins at the voltage and in the kind according to the characteristic information (S40). Thereby, the controller 103 can control the robot 101.

Thus, according to this embodiment, the reconfigurable circuit 140 can be reconfigured in such a way that the control signal suitable for the robot connected to the controller 103 is output. As a result, the controller system 100 can control a variety of mechatronics devices which have different number of I/Os and different characteristics from one another.

In this embodiment, a part of the connecting pins in the connector 161, and the receiving units in the connector 110, which are corresponding to the above part of the pins, are used for communication of the characteristic information, and the remaining connecting pins, and the receiving units corresponding to the above remaining pins are used for communication of the control signal. As the connecting pins and the receiving units used for communication of the characteristic information are different from the connecting pins and the receiving units used for communication of the control signal as described above, setting for the connecting pins and the receiving units, which are used for communication of the characteristic information, is not required to be changed.

On the other hand, the controller 103 may acquire characteristic information through all the connecting pins and all the receiving unit. In this case, the reconfigurable circuit 140 is reconfigured at high speed, because the controller 103 can obtain the characteristic information through all the connecting portions. However, as communication of characteristic information and that of a control signal are performed by using the same connecting pins and the same receiving units in common, it is required to change setting for the connecting pins and the receiving units.

Though this embodiment has a configuration in which the connector 161 includes the connecting pins, and the connector 110 includes the receiving units, there may be applied another configuration in which the connector 110 comprises connecting pins, and the connector 161 comprises receiving units, instead of the configuration of this embodiment. Moreover, the reconfigurable circuit 140 may be configured as an integral-type device which is provided with one of the CPU 120 and the storage unit 130, or both of them.

### Second Embodiment

The difference between a controller system according to a second embodiment which according to the present invention and that according to the first embodiment is that storage units 151 and 152 store extensible markup language (XML) data. Moreover, though the first embodiment has had a configuration in which the controller 103 acquires a control signal by one-way communication from the controller 103 to the robot 101 or 102.

However, in the second embodiment, a controller 103 acquires a control signal by two-way communication between the controller 103 and a robot 101 or 102. Here, explanation of the controller system according to the second embodiment will be eliminated because the controller system according to the second embodiment has the similar configuration to that shown in FIG. 1.

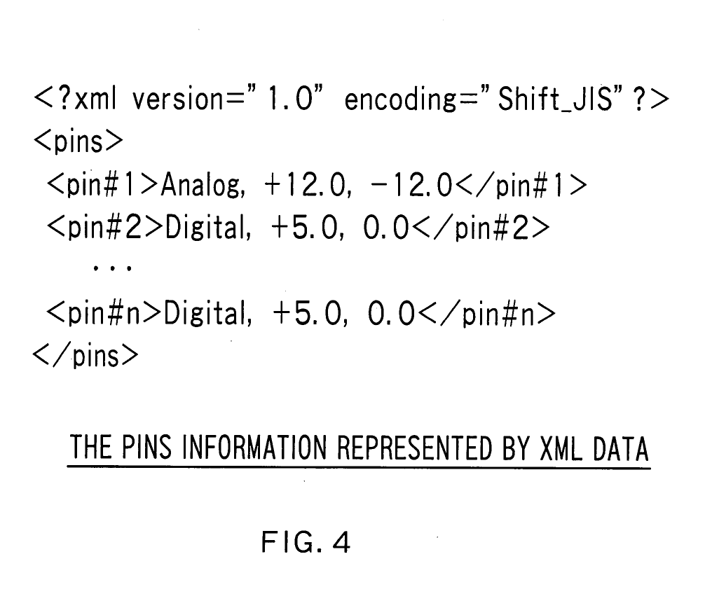

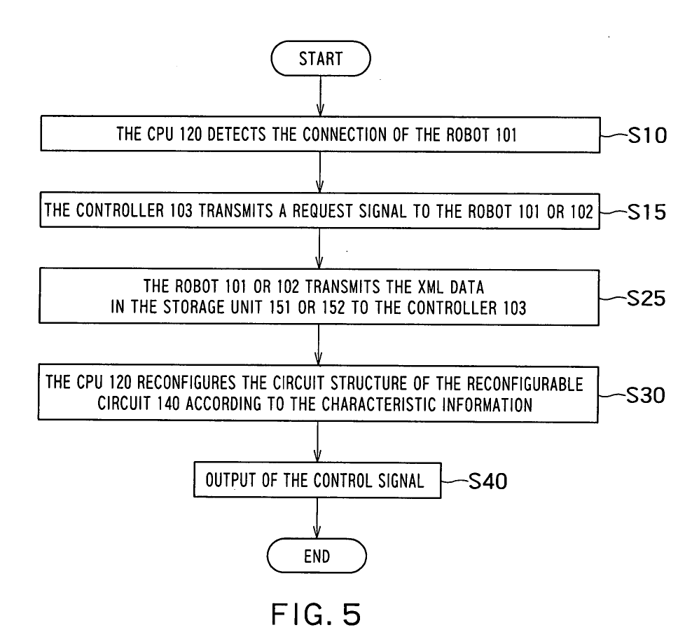

FIG. 4 shows a specific example of XML data stored in the storage unit 151 or 152. FIG. 5 is a flow chart showing an operation flow of the controller system according to the second embodiment. The operations of the second embodiment will be explained, referring to FIG. 1, FIG. 4, and FIG. 5. When the robot 101 is connected to a controller system 100, a CPU 120 in the controller system 100 detects the connection of the robot 101 (S10). Then, the controller 103 transmits a request signal to the robot 101 or 102 (S15). The robot 101 or 102 transmits the XML data in the storage unit 151 or 152 to the controller 103 (S25) according to the above request signal. The CPU 120 reconfigures the circuit structure of a reconfigurable circuit 140 (S30), based on the characteristic information. The reconfigurable circuit 140 transmits the control signal to the controller 103 (S40).

The XML data in FIG. 4 shows a version of the XML in the first line, and it is declared in the second line that each piece of the characteristic information for the control signals passing through connecting pins for communication is specified from the third line. The characteristic information on connecting pins 1 through n is arranged one by one from the third line. The characteristic information shown in FIG. 4 comprises information on the kind representing whether the control signal is of an analog type or a digital one, the maximum voltage of the control signal, and, the minimum voltage of the control signal.

Thus, the circuit structure of the reconfigurable circuit 140 can be changed in the second embodiment by using the XML data. Thereby, in the second embodiment, the characteristic information can be easily changed by rewriting the XML data in the storage units 151 and 152 in the robots 101 and 102. That is, in order to change the characteristic information, the second embodiment is not required to change hardware in the robots 101 and 102 (the storage units 151 and 152).

### Third Embodiment

In a third embodiment, the circuit structure of the reconfigurable circuit is reconfigured from a suitable circuit for a direct current (DC) motor provided with an encoder to a suitable circuit for a DC motor provided with an potentiometer.

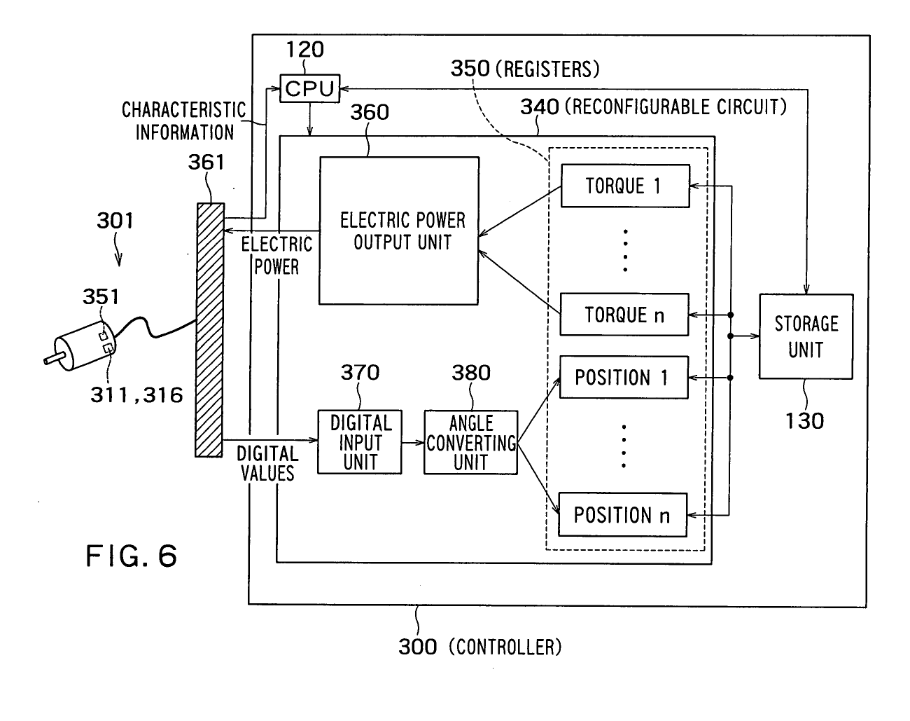

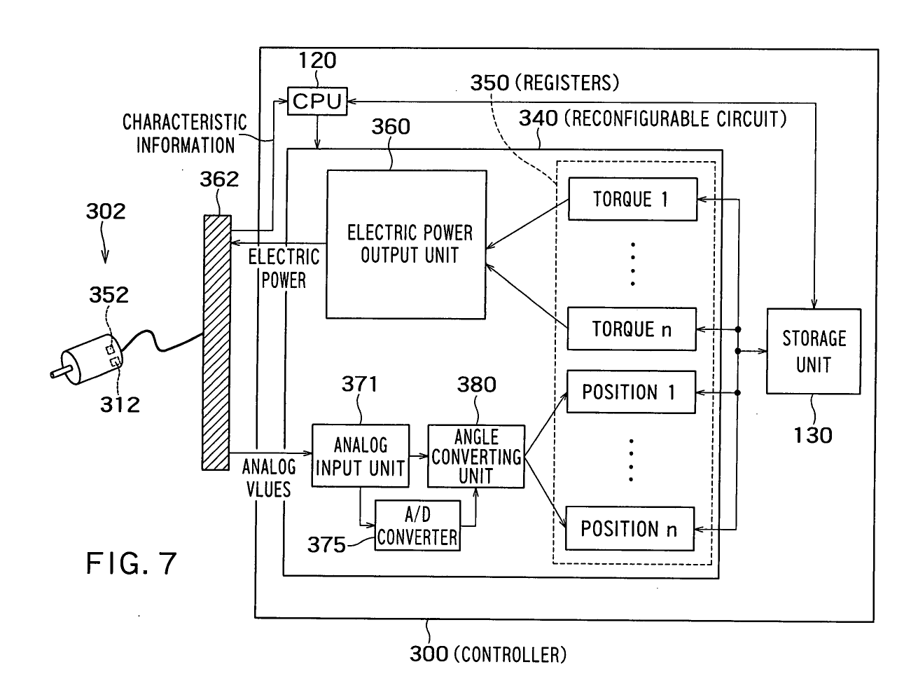

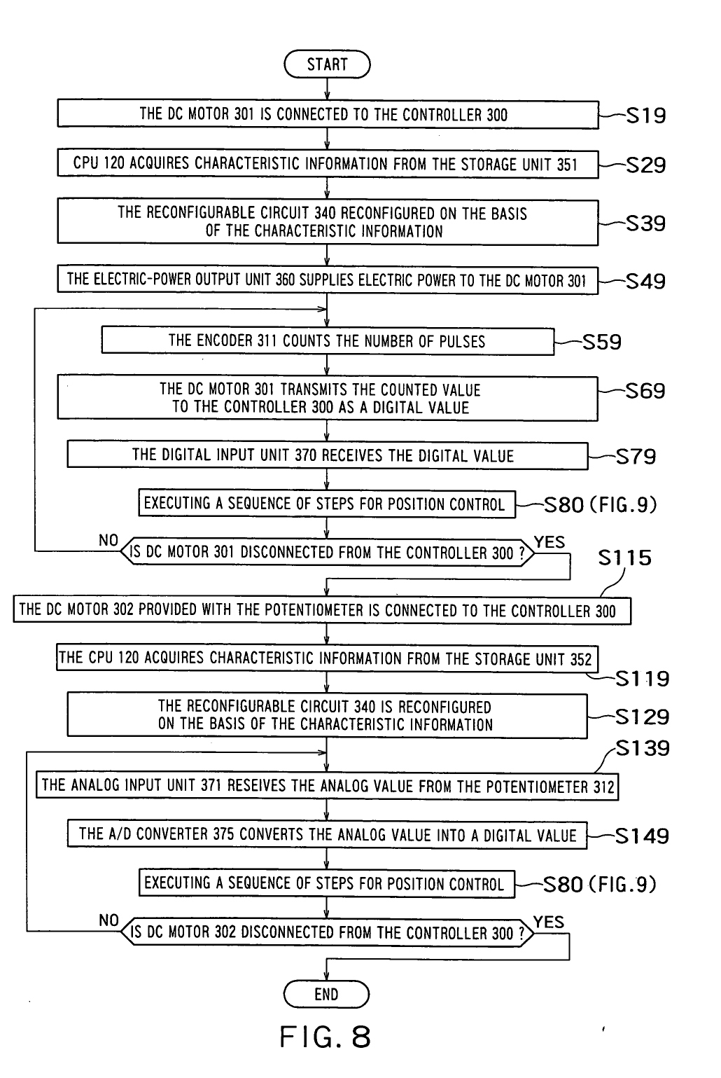

FIG. 6 is a block diagram of a DC motor 301 provided with a controller 300 and an encoder 311 according to the third embodiment of the present invention. FIG. 7 is a drawing showing a configuration in which a DC motor 302 provided with a potentiometer 312, in stead of the DC motor 301, is connected to a controller 300. FIG. 8 is a flow chart showing an operation flow according to the third embodiment.

The DC motor 301 is connected to the controller 300 as shown in FIG. 6. The DC motor 301 comprises the encoder 311 and a storage unit 351. The encoder 311 generates pulse signals according to the rotation of the DC motor 301. The number of pulse signals is proportional to the number of rotations. The pulses are counted with a counter 316. The storage unit 351 stores characteristic information for a control signal by which the DC motor 301 is controlled.

The operation according to the third embodiment will be explained, referring to FIGS. 6 and 8. The DC motor 301 is connected to the controller 300 (S19). Then, a CPU 120 in the controller 300 acquires characteristic information from the storage unit 351 (S29). The characteristic information is, for example, information showing that a signal output from the DC motor 301 is a digital signal, information representing which connecting pin in a connector 361 is a connecting pin for electric-power input to the DC motor 301, and which connecting pin in the connector 361 is a connecting pin for digital input from the encoder 311, and information on voltages of an electric power signal and a digital signal.

The reconfigurable circuit 340 has a circuit structure shown in FIG. 6 on the basis of the characteristic information (S39). At this time, the reconfigurable circuit 340 comprises: a group of registers 350; an electric power output unit 360; a digital input unit 370; and an angle converting unit 380. In the present embodiment, the group of registers 350 includes a plurality of registers, and each register has an allocated and fixed usage. For example, each register in the group of registers 350 stores one of torque information 1 through n and one of position information 1 through n, respectively.

A maximum number of the axes, which the reconfigurable circuit 340 can control, is represented by n. As the maximum number of the axes is one if only one DC motor 301 is connected to the controller 300, registers which stores the torque 2 through n and the position information 2 through n are not required.

Then, the electric-power output unit 360 supplies electric power to the DC motor 301, based on the torque information in the group of registers 350 (S49). The DC motor 301 is rotated by the electric power from the electric-power output unit 360, and the encoder 311 counts the number of pulses proportional to the number of rotations of the DC motors 301 at this time (S59). The DC motor 301 transmits the counted value to the controller 300 as a digital value (S69). The controller 300 receives the digital value in the digital input unit 370 (S79).

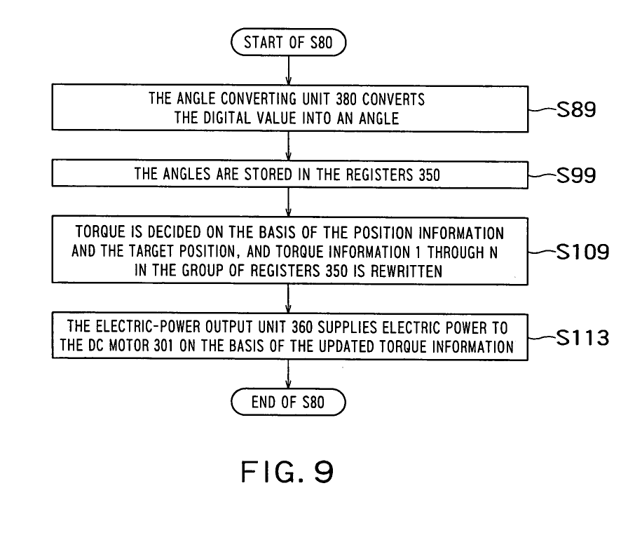

Subsequently, a sequence of steps for position control are executed (S80). The contents of the sequence of steps for position control are shown in FIG. 9. Firstly, the angle converting unit 380 converts the digital values into angles of the DC motor 301 (S89). The angles are stored in the group of registers 350 as the position information 1 through n of the DC motor 301 (S99). The storage unit 130 obtains the position information 1 through n from the group of registers 350. For example, torque is decided on the basis of the position information and the target position in order to control the position, and torque information 1 through n in the group of registers 350 is rewritten (S109). The electric-power output unit 360 supplies electric power to the DC motor 301 on the basis of the updated torque information (S113). While the DC motor 301 is connected to the controller 300, steps from S59 to S113 are repeated. A series of steps from S89 to S113 shown in FIG. 9 is assumed to be the sequence of steps for position control.

Returning to FIG. 8, the DC motor 302 provided with the potentiometer is connected to the controller 300 as the next step (S115). The potentiometer 312 generates an analog value based on the rotation of the DC motor 302. Firstly, the CPU 120 in the controller 300 acquires characteristic information from the storage unit 352 (S119). As the potentiometer 312 outputs the analog value, the characteristic information is, for example, information showing that a signal output from the DC motor 302 is an analog signal, information representing which connecting pin in a connector 362 is a connecting pin for electric-power input to the DC motor 302, and which connecting pin in the connector 362 is a connecting pin for analog input from the potentiometer 312.

Accordingly, the reconfigurable circuit 340 has a circuit structure shown in FIG. 7, based on the characteristic information (S129). At this time the reconfigurable circuit 340 is reconfigured in such a way that the circuit 340 comprises an analog input unit 371 and an analog to digital (A/D) converter 375, instead of the digital input unit 370 in FIG. 6.

Thereby, the analog input unit 371 receives the analog value from the potentiometer 312 (S139), and the A/D converter 375 converts the analog value into a digital value (S149). This digital value is transmitted to the angle converting unit 380. Thereafter, the sequence of the steps for position control at the step S80 is executed in the same manner as that of the controller 300 shown in FIG. 6. The steps S139, S149, and S80 are repeated until the DC motor 302 is disconnected from the controller 300.

As shown in FIGS. 6 through 8, the controller 300 according to the present embodiment can control both a mechatronics device which outputs an analog signal and a mechatronics device which outputs a digital signal. That is, the controller 300 can control the DC motors 301 and 302 regardless of whether a sensor provided to the motors is the encoder 311 or the potentiometer 312.

The third embodiment has adopted the one-axis DC motors 301, 302. However, the controller 300 can control a mechatronics device with an arbitrary number of axes within a limited range of the scale of the reconfigurable circuit 140 and within a limited range of the number of connecting pins because the controller 300 is provided with the registers storing the torque information 1 through n and the position information 1 through n as described above.

### Fourth Embodiment

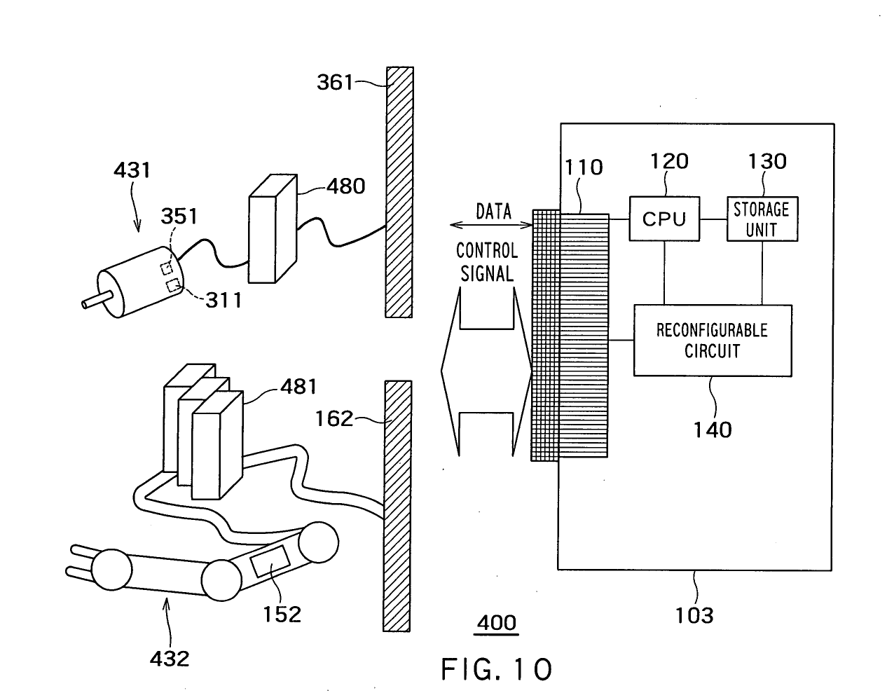

FIG. 10 is a block diagram of a controller system 400 according to a fourth embodiment of the present invention. The difference between the fourth embodiment and the first through third embodiments is that a mechatronics device 431 is provided with a servo amplifier 480 which complements electric power from a controller 103, and a mechatronics device 432 is provided with a servo amplifier 481 which complements electric power from the controller 103. Other component elements in the fourth embodiment may be the same as those in any one of the first through third embodiment.

The controller 103 transmits a current instruction and a speed instruction in an analog value (e.g. a voltage value) to the servo amplifiers 480 and 481. However, in a case that enough electric power can not be output only by a reconfigurable circuit 140, the mechatronics devices 431 may be provided with the servo amplifier 480, and the mechatronics devices 432 may be provided with the servo amplifier 481 as shown in FIG. 10.

In this case, a power amplification rates of the servo amplifier 480 is stored beforehand in a storage unit 152 as characteristic information, and a power amplification rate of the servo amplifier 481 are stored beforehand in the storage unit 351 as characteristic information. Thereby, the controller 103 can output a control signal suitable for the mechatronics device 431 or 432, even when the mechatronics device 431 is provided with the servo amplifier 480, and the mechatronics device 432 is provided with the servo amplifier 481. Moreover, the fourth embodiment eliminates the electric-power output unit 360 shown in FIG. 6 and FIG. 7. Furthermore, the fourth embodiment can have the same advantages as those of the first through third embodiments by combination of the present embodiment and any one of the first through third embodiments.

### Fifth Embodiment

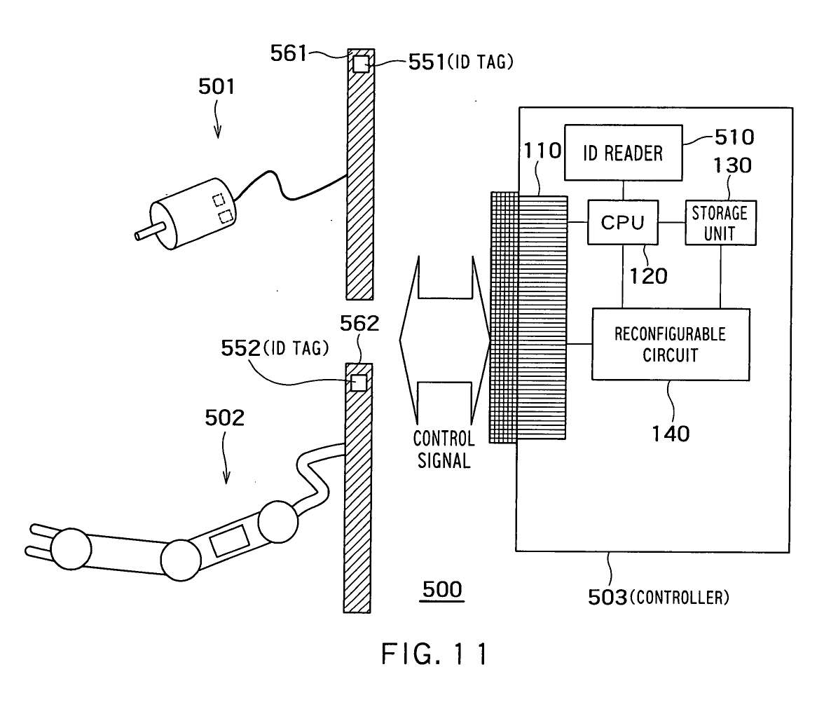

FIG. 11 is a block diagram of a controller system 500 according to the fifth embodiment of the present invention. The difference between the fifth embodiment and the first through fourth embodiments is that a mechatronics device 501 is provided with an identification (ID) tag 551, a mechatronics device 502 is provided with an ID tag 552, and a controller 503 comprises an ID reader 510. Other component elements in the fifth embodiment may be the same as those in any one of the first through fourth embodiment.

The ID tags 551 and 552 are a non-contact-type storage unit, a connector 561 comprises the ID tag 551, and a connector 562 comprises the ID tag 552. The ID tag 551 and 552 stores identification information (hereinafter, simply called ID too) by which the mechatronics device 501 is specified, and the ID tag 552 stores identification information by which the mechatronics device 502 is specified.

On the other hand, the ID reader 510 is a non-contact-type reading device, and reads an ID from the ID tags 551 or 552 before the connectors 561 and 562 are connected to a connector 110. Moreover, a storage unit 130 stores characteristic information corresponding to the ID.

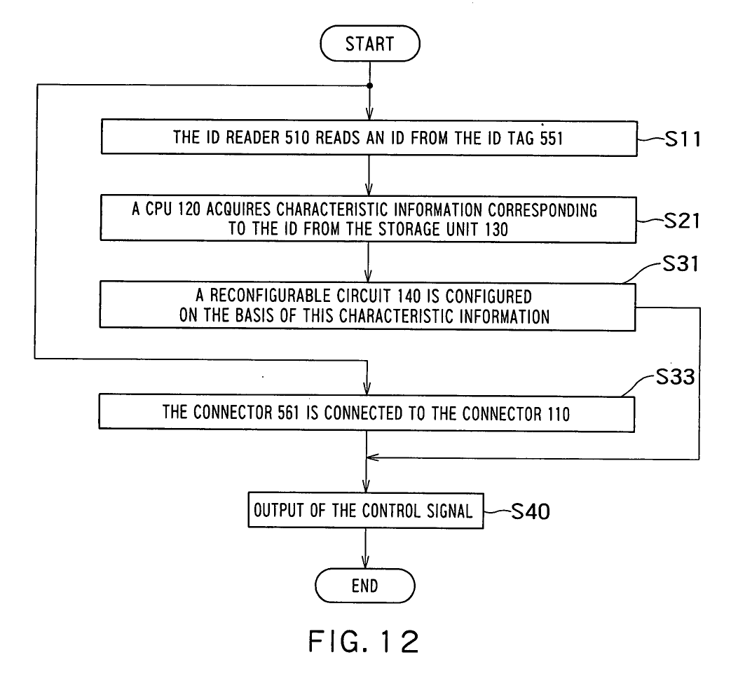

FIG. 12 is a flow chart showing an operation flow of the controller system 500. It is assumed that the mechatronics device 501 is connected to the controller 503. In the first place, the ID reader 510 reads an ID from the ID tag 551 (S11) when the connector 561 approaches the controller 503.

Then, a CPU 120 acquires characteristic information corresponding to the ID from the storage unit 130 (S21), and a circuit for a reconfigurable circuit 140 is configured on the basis of this characteristic information (S31). In parallel with the steps S11 through S31, the connector 561 is connected to the connector 110 (S33). Thereafter, the reconfigurable circuit 140 transmits a control signal suitable for the mechatronics device 501 to the device 501 (S40).

In the fifth embodiment, the ID reader 510 reads an ID by making the ID tags 551 and 552 approach the ID reader 510. Accordingly, the ID reader 510 can read an ID before the connector 561 and 562 are connected to the connector 110 or in parallel with the connection. Thereby, the CPU 120 can configure the reconfigurable circuit 140 at an early stage. Accordingly, a period from the time when the connectors 561, 562 are connected to the connector 110 to the time when the mechatronics devices 501, 502 are controlled by the controller 503 can be reduced in the fifth embodiment. Furthermore, the fifth embodiment can have the same advantages as those of the first through fourth embodiments by combination of the present embodiment and any one of the first through fourth embodiments.

In the fifth embodiment, ID information may be transmitted for communication by using, for example, a wireless LAN or Bluetooth instead of the ID tags 551 and 552.

Though the characteristic information has been stored in the storage unit 130 according to the fifth embodiment, the characteristic information may be stored in the ID tag 551 or 552. In this case, the mechatronics devices 501 and 502 transmit the characteristic information to the controller 503 by wireless communication.

In the first through fifth embodiments, the controller and the mechatronics device may be built in one robot together. The controller in the above embodiments can be applied to various kinds of robots. Thereby, the development cost of the controller can be remarkably reduced. Moreover, the controller can be made smaller and lighter.

Other embodiments of the present invention will be apparent to those skilled in the art from consideration of the specification and practice of the invention disclosed herein. It is intended that the specification and example embodiments will be considered as exemplary only, with a true scope and spirit of the invention being indicated by the following.

1. A controller system comprising:
a mechatronics device comprising a first connector inputting or outputting signals, and a memory which stores characteristic information showing characteristics of the signals input and output through the first connector, and
a controller, which controls the mechatronics device, comprising a second connector which is electrically connected to the first connector; a reconfigurable circuit which outputs control signals controlling the mechatronics device; the reconfigurable circuit being changed to a suitable circuit structure for the mechatronics device; and a processor outputting an instruction to the reconfigurable circuit to change the circuit structure according to the characteristic information.

2. The controller system according to claim 1, wherein
the processor acquires the characteristic information through the first connector and the second connector, which are electrically connected to each other, and the reconfigurable circuit has a circuit structure which is changed to a suitable circuit structure for the control signals passing through the first and the second connectors.

3. The controller system according to claim 1, wherein
the characteristic information passes through a part of the connecting portion between the first connector and the second connector, and the control signals pass through the remnant of the connecting portion between the first connector and the second connector,
wherein the reconfigurable circuit has a circuit structure which is changed to a suitable circuit structure for the control signals passing through the remnant of the connecting portion between the first connector and the second connector.

4. The controller system according to claim 1, wherein
when the circuit structures of the reconfigurable circuit are changed, signal paths between the circuit structures are changed, and signal levels between the circuit structures are changed.

5. The controller system according to claim 1, wherein
the first connector includes a plurality of connecting pins,
wherein the characteristic information includes information on voltages of signals passing through each connecting pin, and information to determine whether the signals passing through each connecting pin are analog signals or digital signals.

6. The controller system according to claim 1, wherein
the first memory is a non-contact-type memory,
wherein the controller includes a non-contact-type reading part which reads the characteristic information from the non-contact-type memory.

7. The controller system according to claim 1, wherein
the control signals include an analog signal.

8. A controller system comprising:
a mechatronics device comprising a first connector inputting or outputting signals; and a first memory which stores identification information by which the mechatronics device is specified, and
a controller, which controls the mechatronics device, comprising a second connector which is electrically connected to the first connector, a second memory which stores characteristic information of signals input and output through the second connector; the second memory storing characteristic information corresponding to the identification information; a reconfigurable circuit which outputs a control signal controlling the mechatronics device, the reconfigurable circuit being changed to a suitable circuit structure for the mechatronics device; and a processor selecting the characteristic information from the second memory on the basis of the identification information received from the mechatronics device, and outputting an instruction to the reconfigurable circuit to change the circuit structure according to the characteristic information.

9. The controller system according to claim 8, wherein
when the circuit structures of the reconfigurable circuit are changed, signal paths between the circuit structures are changed, and signal levels between the circuit structures are changed.

10. The controller system according to claim 8, wherein
the first connector includes a plurality of connecting pins,
wherein the characteristic information includes information on voltages of signals passing through each connecting pin, and information to determine whether the signals passing through each connecting pin are analog signals or digital signals.

11. The controller system according to claim 8, wherein
the first memory is a non-contact-type memory,
wherein the controller includes a non-contact-type reading part which reads the characteristic information from the non-contact-type memory.

12. The controller system according to claim 8, wherein
the reconfigurable circuit is a field programmable gate array.

13. The controller system according to claim 8, wherein
the control signals include an analog signal.

14. A controller, which controls a mechatronics device, comprising:
a connector which is electrically connected to the mechatronics device;
a reconfigurable circuit which outputs control signals controlling the mechatronics device, the reconfigurable circuit being changed to a suitable circuit structure for the mechatronics device; and
a processor outputting an instruction to the reconfigurable circuit to change the circuit structure according to a characteristic information of the mechatronics device, the characteristic information being sent from the mechatronics device connected to the connector.

15. The controller system according to claim 14, wherein
the characteristic information passes through a part of the connector, and the control signals pass through the remnant of the connector,
wherein the reconfigurable circuit has a circuit structure which is changed to a suitable circuit structure for the control signals passing through the remnant of the connector.

16. The controller system according to claim 14, wherein
when the circuit structures of the reconfigurable circuit are changed, signal paths between the circuit structures are changed, and signal levels between the circuit structures are changed.

17. The controller system according to claim 14, wherein
the first connector includes a plurality of connecting pins,
wherein the characteristic information includes information on voltages of signals passing through each connecting pin, and information to determine whether the signals passing through each connecting pin are analog signals or digital signals.

18. A controller, which controls a mechatronics device, comprising:
a connector which is electrically connected to the mechatronics device;
a memory which stores identification information by which the mechatronics device is specified, the memory storing characteristic information corresponding to the identification information;
a reconfigurable circuit which outputs control signals controlling the mechatronics device, the reconfigurable circuit being changed to a suitable circuit structure for the mechatronics device; and
a processor selecting the characteristic information from the memory on the basis of the identification information received from the mechatronics device, and outputting an instruction to the reconfigurable circuit to change the circuit structure according to the characteristic information.

19. The controller system according to claim 18, wherein
when the circuit structures of the reconfigurable circuit are changed, signal paths between the circuit structures are changed, and signal levels between the circuit structures are changed.

20. The controller system according to claim 18, wherein
the first connector includes a plurality of connecting pins,
wherein the characteristic information includes information on voltages of signals passing through each connecting pin, and information to determine whether the signals passing through each connecting pin are analog signals or digital signals.

21. The controller system according to claim 18, wherein
the controller includes a non-contact-type reading part which reads the characteristic information or the identification information from the non-contact-type memory.

22. The controller system according to claim 18, wherein
the reconfigurable circuit is a field programmable gate-array.

23. A robot comprising the controller described in claim 18.
